(19) United States
(12) Patent Application Publication
(10) Pub. No.: US 2005/0258125 A1
(43) Pub. Date: Nov. 24, 2005

(54) Venting two-part closure for a baby bottle

(76) Inventor: Mark William Kiehne, Rochedale South Queensland (AU)

Correspondence Address: SHOEMAKER AND MATTARE, LTD, 10 POST OFFICE ROAD - SUITE 110, SILVER SPRING, MD, 20910, US

(21) Appl. No.: 10/362,370

(22) PCT Filed: Aug. 30, 2001
(86) PCT No.: PCT/AU01/01091

§ 371 Date: Feb. 28, 2003

(30) Foreign Application Priority Data
Aug. 30, 2000 (AU) PQ 9777

(51) Int. Cl. A61J 9/04; A61J 11/02; A61J 9/08

(52) U.S. Cl. 215/11.5; 215/11.1; 215/11.6

(57) ABSTRACT

A venting closure for a threaded neck container (12) filled with a fluid such as milk comprising a first threaded cap (11) having at least one opening (14,15) in an upper region and a second snap cap (13a) having a outlet nozzle (13b) in the form of a teat which is adapted to fit over the first cap, and the first cap (11) is adapted to fit over the opening in a bottle (12). When the second cap is located over the first cap, a channel or flow path (18) extends from the upper region of the first cap (11) between the first cap and the second cap to permit a flow of air between the first and second caps. The air fills the void left in the bottle as a result of liquid leaving trough the nozzle. The flow path (18) extends from the hole (15) around the periphery to a vertical groove (19) which extends three quarters down the outer side surface of the first cap (11). A baby suckling or drinking on the teat (13b) does not ingest air along with the milk and hence reduces the problem of colic.

### FIELD OF THE INVENTION

The present invention primarily relates to bottles of liquid although the invention relates to containers of all types of fluids such as gases, chemical fluids including hazardous chemicals.

### BACKGROUND OF THE INVENTION

A babies bottle normally consists of a plastic bottle with a screw-on cap having a teat or nozzle. A baby sucking on the teat is able to withdraw milk which is located in the bottle.

A baby drinking from a bottle as described above frequently encounters the problem of colic.

This occurs when milk and air is ingested by the baby.

The problem with existing babies bottles is that the battle cap with the teat cannot prevent air passing in through the hole in the teat to the interior of the bottle. Such a flow of air occurs automatically due to the partial vacuum which is created in the nozzle when the baby sucks milk through the hole in the teat.

The present invention aims at producing a closure for a container which reduces problems associated with conventional closures.

### SUMMARY OF THE INVENTION

According to the present invention there is provided a closure for a container of a fluid comprising a first cap component having at least one opening in an upper region and a second cap component having an outlet nozzle which is adapted to fit over the first component, and wherein the first cap component is adapted to fit over an opening in the container and when the second cap component is located over the first cap component, a channel extends from the upper region of the first cap component between the first cap component and the second cap component to permit a flow path for air between the first and second cap components.

Preferably a flow path exit is provided between the is in the first position.

The words “comprising, having, including” should be interpreted in an inclusive sense, meaning that additional features may also be added.

### BRIEF DESCRIPTION OF THE DRAWINGS

A preferred embodiment of the present invention will now be described by way of example only with reference to the accompanying drawings in which:

FIG. 1 shows components of a closure device according to a preferred embodiment of the invention;

FIG. 2 shows a schematic angled side view of an overcap of the closure device shown in FIG. 1;

FIG. 3 shows a bottom angled view of a nozzle cap of an alternative closure device;

FIG. 4 shows one side view of an overcap according to the preferred embodiment;

FIG. 5 shows another side view of the overcap shown in FIG. 4;

FIG. 6 shows a partial top view of another overcap according to the present invention;

FIG. 7a shows a schematic representation of a first method of operation of the closure shown in FIG. 1;

FIG. 7b shows portion of the nozzle cap in section in an operational position relative to the overcap

FIG. 8 shows a schematic representation of air and liquid flow for the first method of operation of the closure shown in FIG. 1;

FIG. 9 shows a top view of an overcap according to a further embodiment of the present invention;

FIG. 10 shows in side sectional view portion of an overcap according to another embodiment of the present invention;

FIG. 11 shows a front view of the overcap shown in FIG. 10;

FIG. 12 shows a front angled view of an overcap according to a further embodiment of the present invention;

FIG. 13 shows a cross-sectional front view of an assembled closure device according to another embodiment of the present invention;

FIG. 14 shows a perspective view of the overcap of the closure device shown in FIG. 13; and

FIG. 15 shows a nozzle cap of the closure device shown in FIG. 13.

### BEST MODE FOR CARRYING OUT THE INVENTION

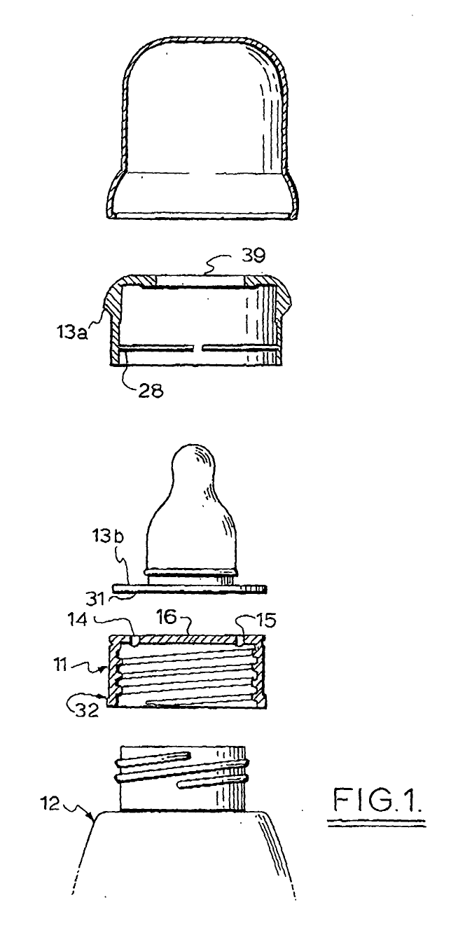

As shown in FIG. 1 a closure device according to the preferred embodiment of the present invention consists of an overcap 11 which is screwed onto a bottle 12 and a nozzle cap 13a, 13b which fits over the overcap 11. Nozzle 13b and cap 13a fit together to form the nozzle cap 13a,13b, the nozzle 13b projecting through a central opening in the cap 13a.

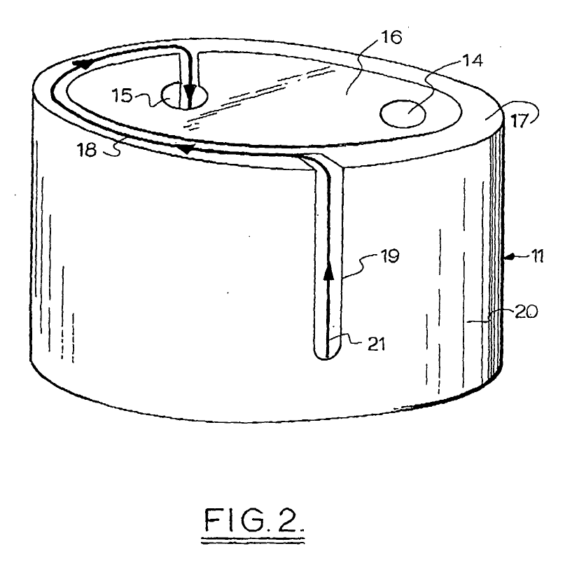

According to one embodiment as shown schematically in FIG. 2, the overcap 15 is generally cylindrical with two symmetrically arranged holes 14, 15 in the upper face 16.

An air flow path 18 extends from hole 15 part way around the periphery 17 of the upper surface 16 to a vertical groove 19 which extends three quarters of the way down the outer side surface 20.

The arrowed line 21 shows the direction of flow of air.

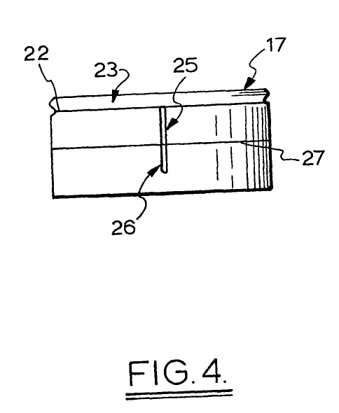

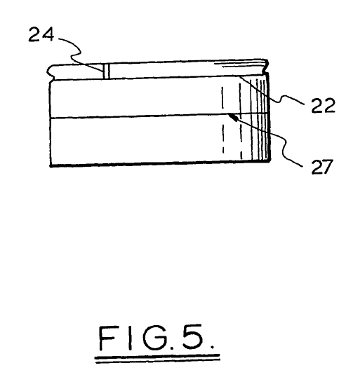

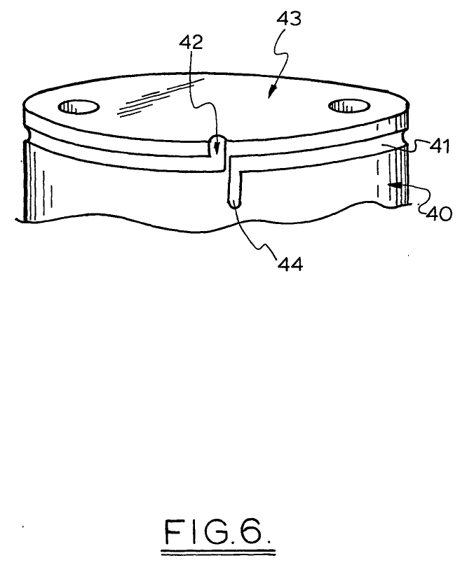

FIGS. 4 and 5 show the preferred embodiment of the overcap 11 in which a circumferential groove 22 is provided around the upper surface 17.

This results in a thin collar 23 being formed.

A vertical slit 24 extends from the upper face to the groove 22.

Around 160° from the slit 24, another pair of slits 25, 26 are provided.

Slit 25 extends vertically down from groove 22 to just above a circumferential ridge 27.

The other slot 26 extends down through and below the ridge 27. A split ridge 28 is formed around the inner circumference of cap 13a.

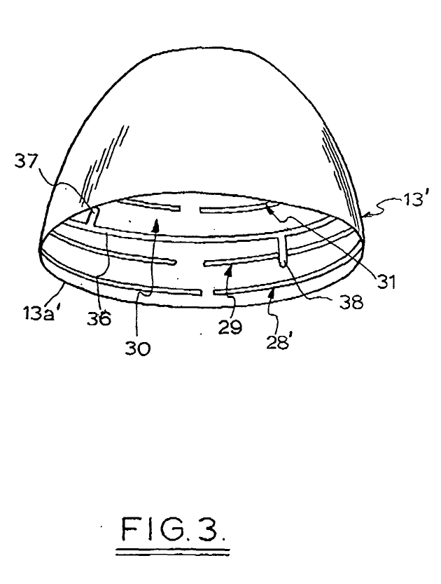

FIG. 3 shows the inner periphery of an alternative nozzle cap 13′ in which the air flow path is formed in cap 13a′.

The cap 13a′ is provided with an inner circumferential ridge 28′ at a lower end thereof followed by a spaced apart stepped region 29 which is located above it.

An area of reduced diameter 30 is located above stepped region 29 and this terminates in an annular seal area 31 which forms the base of nozzle 13b.

The annular seal area 31 is a flat horizontal surface with a large central hole.

In both embodiments, the seal area 31 is adapted to cover both of the openings 14, 15 when the nozzle cap 13 or 13′ is pushed onto the overcap as far as it will go.

Furthermore lower outer circumferential ridge 32 of the overcap 11 forms a seal with the inner circumferential ridge 28 of the nozzle cap 13 or 13′.

An example will now be provided of the operation of the closure device of FIG. 1 when connected to a bottle containing a liquid such as milk.

If the bottle is turned upside down with the nozzle cap 13a, 13b pushed down onto the overcap 11 as far as it will go, no milk will be able to escape through holes 14, 15.

Initially the nozzle cap 13a, 13b is moved upwardly. As a consequence the inner circumferential ridge 28 moves away from contact with the outer circumferential ridge 32 of overcap 11.

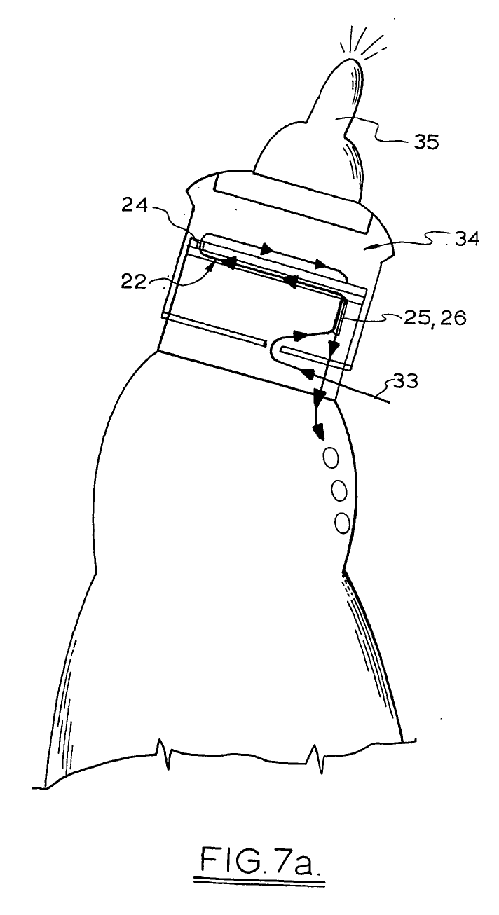

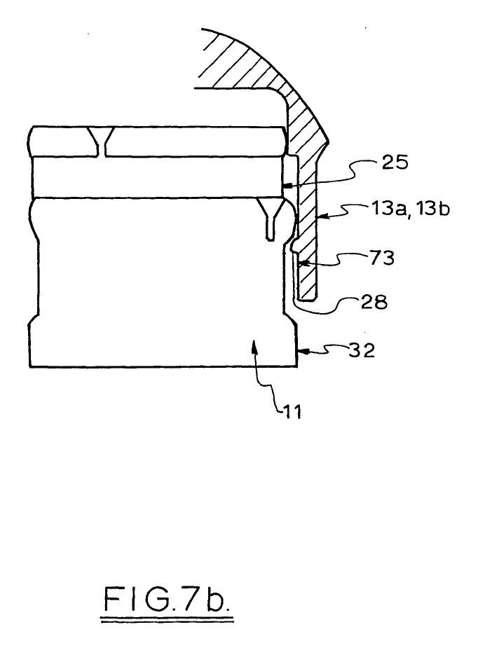

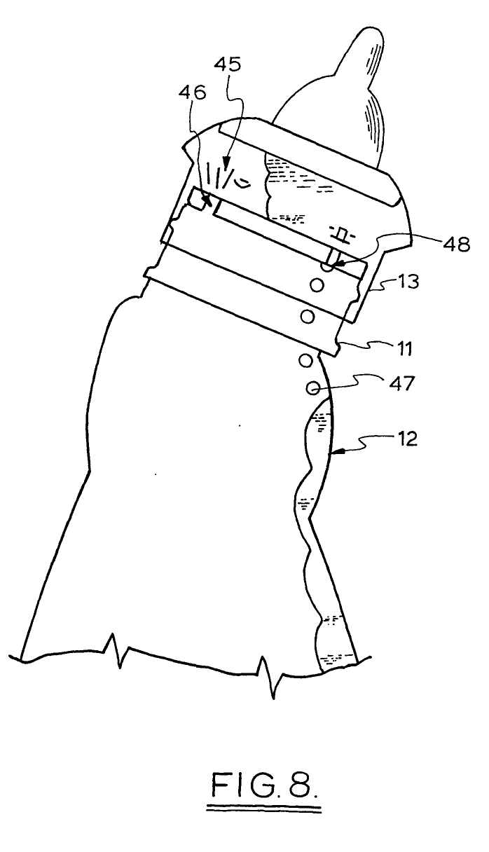

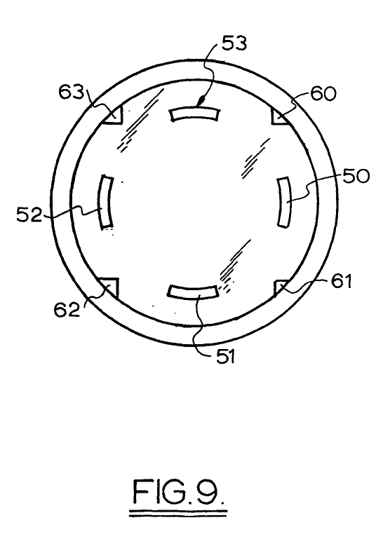

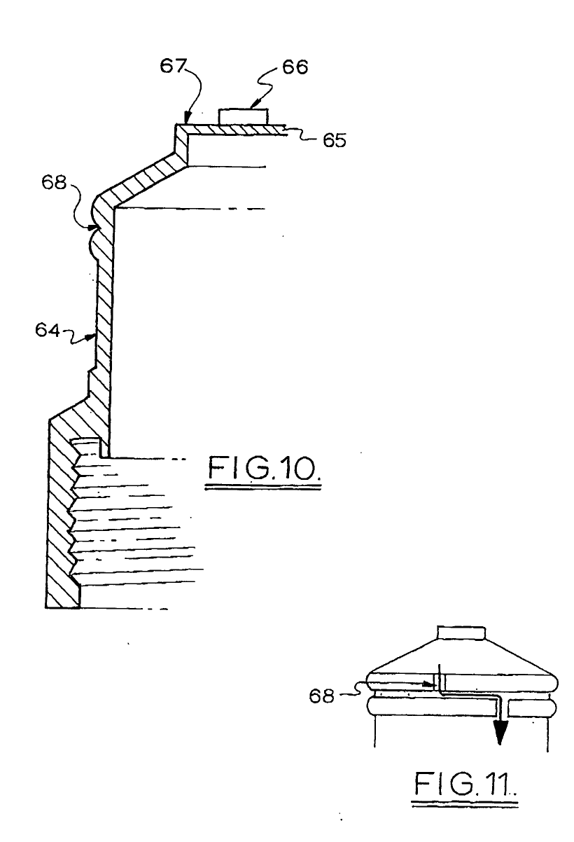

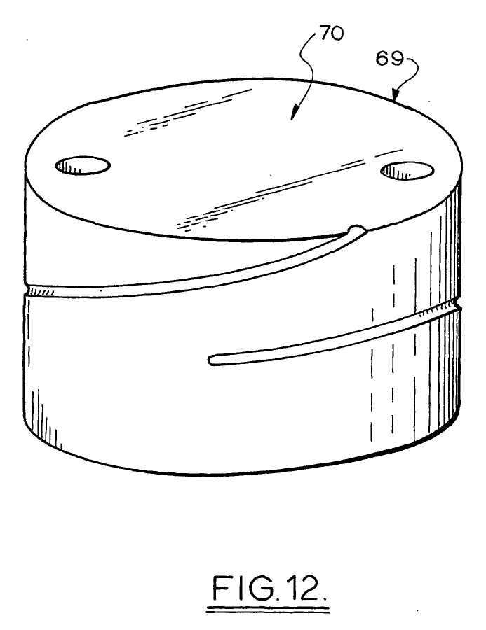

As shown in FIG. 7b a gap 33 is created between the inside wall of the nozzle cap 13a, 13b and the opposing outer peripheral surface of overcap 11.

When the bottle is inverted, milk flows out through hole 14 into chamber 34.

As shown in FIG. 7a air 33 is then able to pass into slits 25, 26 and then travel around the groove 22 into slit 24 and finally into a chamber 34 which is created between the nozzle cap 13a, 13b and the top surface of the overcap 11.

Because of the air flow path 33 which is created, air passes down through hole 15 to fill the void left in the bottle as a result of liquid leaving through hole 14.

Any milk leaving through the nozzle 35 effectively sucks more air 33 in through the bottom of the nozzle cap 13a, 13b along the flow path previously described and into the bottle.

Because air follows a path of least resistance, there is a greater tendency for air to pass into the bottle from between nozzle cap 13a, 13b and overcap 11 as opposed to through the opening in nozzle 35.

As a result only liquid such as milk passes through the opening in the nozzle 35 and a baby suckling on the nozzle 35 does not ingest air along with the milk.

This is because there is no air present in the tip of nozzle 35.

FIG. 7b accentuates the gap which is created between the inner surface of nozzle cap 13a, 13b and the opposing surface of the overcap 11 in the region of the slits 25, 26.

It should be noted that in FIG. 3 a reverse configuration is possible whereby slits or grooves are provided in the cap 13a′ in order to provide a flow path for air entering underneath the nozzle cap 13′.

Thus in FIG. 3 inner circumferential groove 36 is shown between stepped region 29 and area 30. Above the groove 36 a vertical slit 37 is provided. Below the groove 36 and laterally distal to slit 37, a downwardly extending vertical groove 38 is provided.

When the nozzle cap 13′ is lifted upwardly so that a chamber exists between the inner surface of cap nozzle 13b and opposing surface of overcap 11, air is able to pass into slit 38 along groove 36, up slit 37 and to the chamber.

In such an embodiment the outer surface of the overcap 11 would be configured to prevent air flow except through the slits and channels as described above.

In another mode of operation of the closure device, the bottle is placed in an upright position so that milk is able to drain back into the interior of the bottle. When this occurs milk drains back to the interior of the bottle through one of the holes 14, 15 and any air is able to escape along the air flow path in the reverse direction to that described previously. It is preferred that the channels and slits are sized so that milk or whatever other liquid is escapes through the air flow channel.

It also envisaged that the closure device can be modified to make it easier to deliver liquid into a container. For example the overcap could be modified so that it has a main inlet which allows easy entry of liquid or fluid from a fluid delivery device, in such a situation a small airhole may he provided which is able to communicate with an air flow channel in the manner previously described.

According to another embodiment the air flow channel could be modified so that an escape outlet is provided in the nozzle cap, which escape opening may be opened or closed by a separate sealing device.

According to another variation of the present invention only part of the nozzle cap is required to be moved in order to open and close the air flow channel. For example a side wall of the nozzle cap may be moveable to block or unblock the air flow channel to control movements of air therethrough or therealong.

It should be noted that the nozzle cap does not need to be shaped like a conventional nozzle but may include a cap having an opening for entry or exit of fluid.

According to another embodiment of the present invention the nozzle cap includes a moveable sealing means.

The moveable sealing means may include a seal.

The seal may be part of a slidable closure which fits over the nozzle cap.

The moveable seal may be a screw-on seal.

According to another embodiment of the present invention the nozzle cap includes a valve opening for limiting flow of fluid to one direction. This may be in or out of the container to which the closure device is connected.

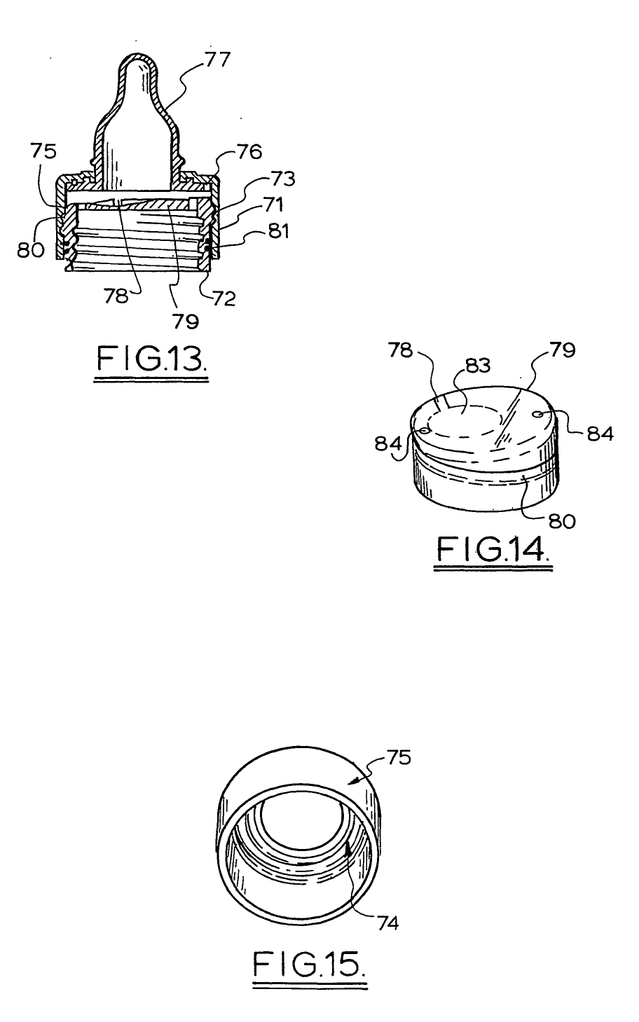

The closure device 71 shown in FIG. 13 shows an overcap 72 suitable for a bottle having a straight neck. The periphery of the overcap 72 is provided with a short section of thread 73 which engages with an inside threaded section 74 of the nozzle cap 75.

In contrast to previous embodiments the nozzle cap is able to be screwed with respect to the overcap 72in order to raise or lower the nozzle cap 75 and therefore move the collar 76 of the nozzle 77 up or down.

Groove 78 extends from the top surface 79 of the overcap 72 and forms the beginning of an airflow channel 80 which is formed in the outer periphery of the overcap and exits at a location 81 slightly above the lowermost point of the nozzle cap 75.

The bevelled top surface 79 of the overcap 72 also has a scalloped region 83.

By screwing the nozzle cap 75 in one direction the nozzle 77 and collar 76 are raised to provide a space between the collar 76 and the upper surface 79.

Liquid is therefore able to pass out of a hole 84 in the top surface of the overcap 71 and air into a hole 84 from channel 80.

The bevelled top surface 79 and scalloped region 83 assist with airflow through the airflow channel 80.

When the nozzle cap 75 is screwed in the opposite direction the collar 76 moves down to block the holes 84 and therefore prevent passage of liquid from the bottle on which the closure device is attached.

A hole may be provided in the side wall of the nozzle cap 75 in order to align with the exit point 81 so as to provide an easy exit to the outside environment.

It is to be understood that, if any prior art publication is referred to herein, such reference does not constitute an admission that the publication forms a part of the common general knowledge in the art, in Australia or in any other country.

1-28. (canceled)

29. A closure for a container of a fluid comprising a first cap component having an outer peripheral surface and at least one opening in an upper region and a second can component having an outlet nozzle located over the first cap component, and wherein the first can component is adapted to be engaged with said container such that said at least one opening communicates with the interior of said container, and a channel extending from the upper region of the first cap component and between the first cap component and the second can component and defining a flow path for air between the outside environment and the first and second cap components and the interior of said container through said at least one opening, said channel comprising a main slot or groove extending in a circumferential direction relative to said first car component, said slot or groove communicating at spaced apart positions therealong with said upper region of said first cap component and with the outside environment respectively, wherein said first cap component has an outer peripheral surface and wherein said channel includes at least one further slot or groove in the outer peripheral surface of the first cap component and extending in an axial direction relative to said first cap component.

30. The closure as claimed in claim 29 wherein said main slot or groove is formed in an upper surface of said first cap component and communicates with said at least one further slot or groove.

31. The closure as claimed in claim 29 wherein said main slot or groove is located adjacent said upper region of said first cap component.

32. The closure as claimed in claim 31 wherein said at least one further slot or groove comprises a first slot or groove communicating said main slot or groove with said upper region of said first cap component and a second slot or groove communicating said main slot or groove with the outside environment.

33. The closure as claimed in claim 32 wherein said first and second slots or grooves are provided above and below said main slot or groove respectively.

34. The closure as claimed in claim 29 including a flow path exit to allow air in said channel between the first and second cap components to communicate with the outside environment, said exit comprising a gap between a bottom edge of the second cap component and an opposing outer surface of the first cap component.

35. The closure as claimed in claim 29 wherein said channel main slot or groove is formed in an inner peripheral surface of said second cap component.

36-37. (canceled)

38. The closure as claimed in claim 29 for a container of a fluid comprising a first cap component having at least one opening in an upper region and a second cap component having an outlet nozzle located over the first cap component, and wherein the first cap component is adapted to be engaged with said container such that said at least one opening communicates with the interior of said container, and a channel extending from the upper region of the first cap component and between the first cap component and the second cap component and defining a flow path for air between the outside environment and the first and second cap components and the interior of said container through said at least one opening, said channel comprising a main slot or groove extending in a circumferential direction relative to said first cap component, said slot or groove communicating at spaced apart positions therealong with said upper region of said first cap component and with the outside environment respectively wherein the said second cap component selected being mounted for slidable movement relative to said first cap component between a first operational position in which a chamber is formed between said first and second cap components whereby fluid is able to flow through a said opening in the first cap component into said chamber for passage through said outlet nozzle and a second non-operational position wherein said second cap component closes said at least one opening.

39. The closure as claimed in claim 38 wherein the second cap component is threaded to said first cap component for rotational and axial movement relative to said first cap component between said first and second positions.

40. The closure as claimed in claim 29 wherein said upper region of said first component includes an upper face and wherein the or each said opening is formed through said upper face.

41. The closure as claimed in claim 40 wherein the second cap component includes an inner sealing means for closing the or each said opening through the face of said first cap component when the second cap component is in said second position.

42. The closure as claimed in claim 41 wherein said nozzle of said second cap component comprises a separate nozzle member and wherein said second cap component has an opening through which a portion of said nozzle member projects.

43. The closure as claimed in claim 42 wherein said nozzle member includes an annular flange positioned between said second cap component and said first cap component and comprises said sealing means for sealing said at least one opening.

44. A closure for use with a baby's bottle, said closure comprising: a first cap component having at least one opening in an upper region, said first cap component being adapted to be engaged with said bottle such that said at least one opening communicates with the interior of said bottle;
a second cap component adapted to be located over the first cap component, said second cap component having a central opening therein;
a nozzle member having a portion projecting through said central opening in said second cap component and a base flange on an underside portion of said second component; said second cap component being movable relative to sad said first cap component between a first inoperative position wherein said base flange is adjacent said upper region of said first component to seal said at least one opening and a second operative position in which a chamber is formed between said first and second cap components whereby liquid in said baby's bottle may pass through at least one said opening into said chamber and through said nozzle; and
air channel means communicating the interior of said baby's bottle with the external atmosphere through said at least one said opening when said second cap component is in said operative position, said air channel means being defined between said first and second cap components and comprising a groove extending peripherally of said first cap component, first means communicating said groove with said upper region of said first cap component and second means communicating said groove with the external atmosphere and wherein said first communicating means is spaced peripherally from said second communicating means.

45. (canceled)

46. The closure of claim 44 wherein said first and second communicating means comprise slots or grooves extending in an axial direction relative to said first cap component.

47. A closure for use with a baby's bottle, said closure comprising: a first cap component having a plurality of openings therein, said first cap component being adapted to be engaged with said bottle such that said openings communicate with the interior of said bottle;
a second cap component adapted to be located over the first cap component, said second cap component having a central opening therein;
a nozzle member having a portion projecting through said central opening in said second cap component and a base flange on an underside portion of said second component; said second cap component being movable relative to said first cap component between a first inoperative position wherein said base flange is adjacent said upper region of said first component to seal said openings and a second operative position in which a chamber is formed between said first and second cap components whereby liquid in said baby's bottle may pass through at least one said opening into said chamber and through said nozzle; and
air channel means communicating the interior of said baby's bottle with the external atmosphere through a further said opening when said second cap component is in said operative position, said air channel means comprising a groove extending peripherally of said first cap component, said groove communicating at spaced apart positions therealong with said upper region of said first cap component and the external atmosphere respectively.

48. The closure of claim 47 wherein said first cap component has an outer surface and wherein said groove is formed in said outer surface.

49. The closure of claim 48 wherein said air channel means includes first and second slots communicating with said groove at said spaced positions therealong and extending in an axial direction relative to said first cap component, said first slot further communicating with the upper region of said first cap component and said second slot further communicating with the external atmosphere.
